(19) United States
(12) Patent Application Publication
(10) Pub. No.: US 2006/0222413 A1
(43) Pub. Date: Oct. 5, 2006

(54) TONER CONTAINER AND FULL COLOR IMAGE FORMING DEVICE

(75) Inventor: Rumi NAGAE, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/278,148

(22) Filed: Mar. 31, 2006

(30) Foreign Application Priority Data
Mar. 31, 2005 (JP) 2005/101206

(51) Int. Cl. G03G 15/08

(52) U.S. Cl. 399/262

(57) ABSTRACT

Toner containers are disclosed which are arranged in a horizontal direction, each toner container including (a) a container body that has an opening formed in the top thereof, and a first brim member formed around the entire circumference of the opening so as to protrude outward, and (b) a container lid that has an opening formed in the bottom thereof, and a second brim member formed around the entire circumference of the opening so as to protrude outward and connected to the first brim member. Here, the left side brim member and the right side brim member of the first brim member and the second brim member are formed in different positions in the vertical direction.

### CROSS-REFERENCE TO RELATED APPLICATIONS

This application claims priority to Japanese Patent Application No. 2005-101206. The entire disclosure of Japanese Patent Application No. 2005-101206 is hereby incorporated herein by reference.

### BACKGROUND OF THE INVENTION

1. Field of the Invention

The present invention relates to toner containers. More specifically, the present invention relates to toner containers that are arranged in a single direction. In addition, the present invention relates to a full color image forming device in which a plurality of toner containers are stored.

2. Background Information

In a conventional image forming device, a predetermined amount of toner is filled into a developing unit, and the developing unit itself is replaced when the toner is depleted for the purpose of simplifying maintenance of the image forming device. However, it is not economical to replace the developing unit often. Therefore, it is necessary to increase the capacity of the developing unit in which toner is filled in a conventional image forming device. As a result, miniaturization of the developing unit has been difficult. In order to miniaturize the developing unit, adopting a developing unit having toner supplied from an external unit has been proposed. For example, Japan Patent Application Publications JP-A-2003-208007 and JP-A-09-269716 disclose developing units having toner supplied from an external unit. The developing units in these publications include a plurality of toner containers arranged in a single direction in order to supply toner. Generally, each toner container is comprised of a container in which a protruding portion is formed around the entire circumference. For example, the container is comprised of a container body that contains toner in the interior thereof, and a container lid that is fixed on the container body. The container body is open at the top, and the container lid is open at the bottom. In addition, brim portions are formed around the entire circumference of the container body and the container lid and protrude outward. These brim portions formed on the container body and the container lid are welded by ultrasonic waves, and thus the container body and the container lid are joined without any gap therebetween. According to the image forming device disclosed in the aforementioned publications, a plurality of toner containers for supplying toner are arranged in one direction. However, when the plurality of toner containers are arranged in a single direction, the brim portions 101a, 102a, 103a, and 104a of the four adjacent toner containers 101, 102, 103, and 104 are next to each other and aligned in the same height, as shown in FIG. 1. Therefore, it is necessary to keep a predetermined distance “D” between the adjacent toner containers so that the adjacent four brim members 101a, 102a, 103a, and 104a of the four toner containers 101, 102, 103, and 104 do not interfere with each other. Because it is necessary to keep a predetermined distance between each of the adjacent toner containers, a large space is required in order to arrange a plurality of toner containers in a single direction in a conventional device.

In view of the above, it will be apparent to those skilled in the art from this disclosure that there is a need for an improved image forming device that will reduce the space required for toner containers by reducing the distance between the adjacent toner containers and thus miniaturize the image forming device, and increase the capacity of the toner containers without increasing the sizes thereof, and thus reduce the burden of having to replace toner. This invention addresses this need in the art as well as other needs, which will become apparent to those skilled in the art from this disclosure.

### SUMMARY OF THE INVENTION

In accordance with a first aspect of the present invention, a toner container is comprised of a container configured to contain toner in the interior thereof, a first protruding portion formed on one of the lateral sides thereof so as to protrude in the first direction, and a second protruding portion formed on the lateral side facing the lateral side on which the first protruding portion is formed. Here, the first protruding portion and the second protruding portion are located in different positions in a second direction perpendicular to the first direction.

According to the first aspect of the present invention, the first protruding portion and the second protruding portion are formed in different positions in the vertical direction. Therefore, when a plurality of the toner containers are arranged parallel to each other in one direction, even if adjacent toner containers are arranged close to each other, it is possible to prevent these protruding portions from interfering with each other. Accordingly, it is possible to reduce the space needed to arrange a plurality of toner containers parallel to each other in one direction, compared to the case in which the first protruding portion and the second protruding portion, both of which are arranged in the same position in a second direction perpendicular to the first direction, are arranged to be parallel to each other in one direction.

In accordance with a second aspect of the present invention, the toner container according to the first aspect of the present invention further comprises (a) a container body that has an opening formed therein, and a container body side brim member formed around the entire circumference of the opening of the container body and which protrudes outward, and (b) a container lid that covers the opening of the container body and which includes an opening formed therein, and a container lid side brim member which is formed around the entire circumference of the opening of the container lid to protrude outward and connected to the container body side brim member. Here, the container body side brim member and the container lid side brim member, respectively, include the first protruding portion and the second protruding portion. In addition, the first protruding portion and the second protruding portion are arranged in different positions in the second direction.

According to the second aspect of the present invention, the first protruding portion and the second protruding portion, both of which respectively form a portion of the container body side brim member and the container lid side brim member, are arranged in different positions in the second direction. Therefore, when a plurality of the toner containers are arranged to be parallel to each other in the first direction, it will be possible to prevent these protruding portions from interfering with each other, even if the adjacent toner containers are arranged close to each other. Accordingly, it will be possible to reduce the space needed to arrange a plurality of the toner containers to be parallel to each other in the first direction, compared to the case in which the first protruding portion and the second protruding portion, both of which are arranged in the same position in a second direction, are arranged to be parallel to each other in one direction.

In accordance with a third aspect of the present invention, in the toner container according to the second aspect of the present invention, a pair of protruding portions connecting the first protruding portion and the second protruding portion are formed on opposing lateral sides of the toner container.

According to the third aspect of the present invention, it will be easy to weld the container body side brim member formed on the container body and the container lid side brim member formed on the container lid because they are formed along a plane.

In accordance with a fourth aspect of the present invention, in the toner container according to the second aspect of the present invention, the container body further includes a toner agitating mechanism that agitates toner in the interior thereof.

In accordance with a fifth aspect of the present invention, in the toner container according to the third aspect of the present invention, the container body further includes a toner agitating mechanism that agitates toner in the interior thereof.

In accordance with a sixth aspect of the present invention, a full color image forming device that forms an image with a plurality of color toners is comprised of (i) an image forming unit that forms an image, (ii) a fixing unit that fixes the image formed in the image forming unit on a print sheet, (iii) a sheet transport unit that transports the print sheet to the image forming unit and the fixing unit, and (iv) a toner supply unit that supplies toner for the image forming unit and comprises a plurality of toner containers arranged in a first direction. Here, each of the toner containers is comprised of (a) a container body configured to contain toner in the interior thereof and which has an opening formed therein, and a container body side brim member formed around the entire circumference of the opening of the container body so as to protrude outward, and (b) a container lid that has an opening formed therein, and a container lid side brim member which is formed around the entire circumference of the opening of the container lid so as to protrude outward and is connected to the container body side brim member. In addition, the plurality of toner containers are arranged so that the container body side brim member and the container lid side brim member formed on adjacent toner containers of the plurality of toner containers are not arranged in the same position in a second direction perpendicular to the first direction, and at least a portion of the container body side brim member and the container lid side brim member formed on adjacent toner containers are arranged to overlap in the first direction.

According to the sixth aspect of the present invention, in the full color image forming device, the container body side brim member and the container lid side brim member are arranged in different positions in the second direction. Therefore, when a plurality of the toner containers are arranged to be parallel to each other in the first direction, it will be possible to prevent these protruding portions from interfering with each other, even if the adjacent toner containers are arranged to be close to each other. Accordingly, it is possible to reduce the space needed to arrange a plurality of the toner containers to be parallel to each other in the first direction, compared to a conventional device. Thus, it is possible to miniaturize the image forming device. In addition, if the amount of space occupied by the toner containers in a conventional image forming device is the same as the space occupied by the toner containers in this full color image forming device, the container body side brim member and the container lid side brim member, both of which are formed on the adjacent toner containers, will not interfere with each other. Therefore, it is possible to increase the capacity of the toner containers, and thus ease the task of replenishing the toners.

In accordance with a seventh aspect of the present invention, in the full color image forming device according to the sixth aspect of the present invention, the container body side brim member and the container lid side brim member respectively include (a) a first protruding portion respectively formed on one lateral side of the container body and the container lid in the first direction, and (b) a second protruding portion formed on a lateral side facing the lateral side on which the first protruding portion is formed in the first direction. Here, the first protruding portion and the second protruding portion are formed in different positions from each other in the second direction.

According to the seventh aspect of the present invention, the same type of toner containers can be arranged in the first direction. Accordingly, the cost of manufacturing the same type of toner containers can be reduced compared to that of different types of toner containers.

In accordance with an eighth aspect of the present invention, in the full color image forming device according to the sixth aspect of the present invention, the first protruding portion and the second protruding portion are formed to face each other and are inclined along a slope.

According to the eighth aspect of the present invention, it is possible to reduce the space needed to align a plurality of toner containers parallel to each other in the first direction, compared to the case in which the first protruding portion and the second protruding portion, both of which are arranged in the same position in a second direction, are arranged to be parallel to each other in the first direction.

In accordance with a ninth aspect of the present invention, in the full color image forming device according to the sixth aspect of the present invention, at least two of the plurality of toner containers are formed to be the same shape, and the adjacent toner containers of the plurality of toner containers are arranged in different positions from each other in the second direction.

In accordance with a tenth aspect of the present invention, in the full color image forming device according to the sixth aspect of the present invention, the plurality of toner containers are detachable from the toner supply unit along a third direction that is perpendicular to the direction the toner containers are aligned.

In accordance with an eleventh aspect of the present invention, in the toner container according to the first aspect of the present invention, the container body side brim portion and the container lid side brim portion are attached to each other by means of welding.

In accordance with a twelfth aspect of the present invention, in the full color image forming device according to the sixth aspect of the present invention, one of the plurality of toner containers is larger than the other toner containers.

In accordance with a thirteenth aspect of the present invention, in the full color image forming device according to the sixth aspect of the present invention, the plurality of toner containers are arranged so that the positions of the container body side brim members are alternately arranged in different positions in the second direction.

As described above, the present invention makes it possible to reduce the space in which the toner containers are arranged when a plurality of toner containers are arranged in a single direction.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a diagram showing a plurality of toner containers arranged in parallel.

FIG. 2 is a schematic view of a color printer in accordance with one embodiment of the present invention.

FIG. 3 is a detailed cross-sectional diagram of a toner supply device.

FIG. 4A is a diagram showing a plurality of toner containers arranged in parallel.

FIG. 4B is an oblique view of a plurality of toner containers arranged in parallel.

FIG. 5 is a diagram showing an example of the layout of toner containers in accordance with another embodiment of the present invention.

FIG. 6 is a diagram showing an example of layout of toner containers in accordance with another embodiment of the present invention.

FIG. 7 is a diagram showing an example of layout of toner containers in accordance with another embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

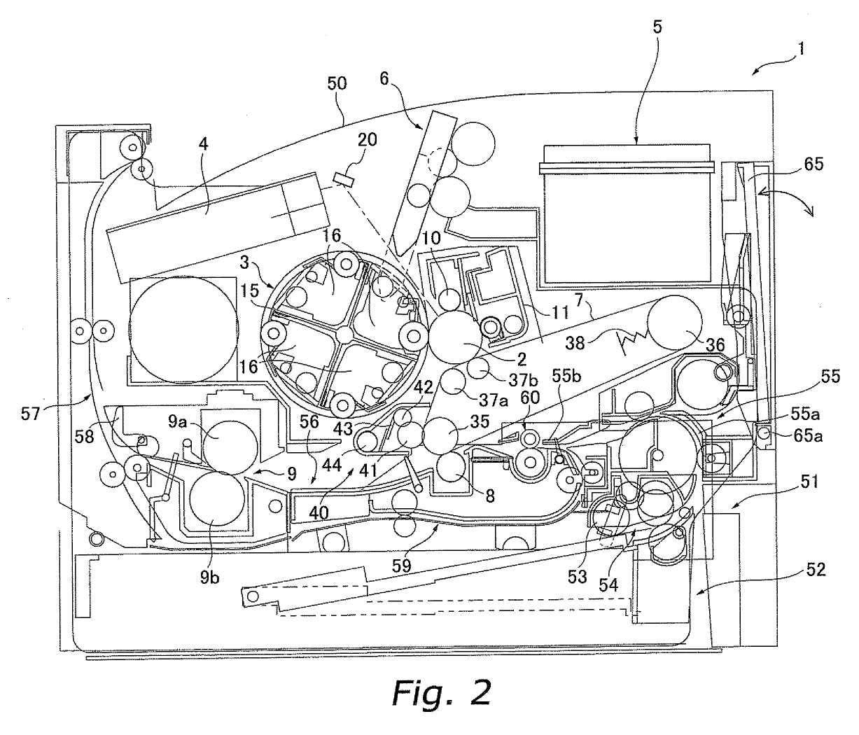

FIG. 2 shows a color printer 1 functioning as an image forming device in which a sheet transport unit is installed in accordance with one embodiment of the present invention. FIG. 2 is an overall structural view showing a layout of each of the components inside the color printer 1. Details of each of the components are not shown in the figure.

Overall Structure

The color printer 1 is connected to a device, such as a computer (not shown in the figure). It is capable of printing a color image on a print sheet based on image data received from the computer. The right side of the color printer 1 shown in FIG. 2 is the side on which an operator operates the color printer 1. The right side of the color printer 1 is hereinafter called “the front side” of the color printer 1. On the other hand, the left side of the color printer 1 is hereinafter called “the rear side” of the color printer 1.

The color printer 1 comprises a photosensitive drum 2, a rotary developing device 3, a laser unit 4, a toner storage unit 5, a toner supply device 6, an intermediate transfer belt 7, a second transfer roller 8, and a fixing device 9.

Photosensitive Drum

The photosensitive drum 2 is mounted substantially in the center of the color printer 1, and is able to rotate freely. An electrostatic latent image of the image data is formed on the surface of the photosensitive drum 2. The rotational shaft of the photosensitive drum 2 extends in a lateral direction when viewed from the front side of the device. In other words, it is located in the direction perpendicular to the cross-section of the color printer 1 shown in FIG. 2. This direction is hereinafter referred to as the “lateral direction.” A charge roller 10 that uniformly charges the surface of the photosensitive drum 2 is mounted on the top of the photosensitive drum 2. In addition, a drum cleaning device 11 that cleans the residual toner and attachments on the surface of the photosensitive drum 2 is mounted to the front side of the photosensitive drum 2.

Rotary Developing Device

The rotary developing device 3 is a device that develops the electrostatic latent image formed on the photosensitive drum 2 with various color toners. The rotary developing device 3 is located adjacent to the photosensitive drum 2, with its center approximately aligned with the center of the photosensitive drum 2.

The rotary developing device 3 comprises a rotary frame 15 and four sub rotary developing units 16 that are supported by the rotary frame 15 and contains four color toners. The rotary frame 15 is a cylindrical member rotatable around an axis parallel with the rotational shaft of the photosensitive drum 2. It is driven by a drive mechanism including a motor and gears (not shown in the figure). In addition, the rotary frame 15 has four compartments that are formed by dividing the rotary frame 15 into quarters with partitions radially extending from the center of the rotational axis outward. Each of the compartments accommodates each of the sub rotary developing units 16, which contain four color toners of cyan, magenta, yellow, and black in the four compartments, respectively.

The structure of each of the sub rotary developing units 16 is substantially the same. Each of the sub rotary developing units 16 comprises a developing roller that can be placed opposite to the photosensitive drum 2, and an agitation roller that agitates the toner. In the present invention, a toner container to be described below is located apart from the sub rotary developing units 16. Because of this, the space in which toner is contained in the sub rotary developing units 16 in accordance with the present embodiment is formed to be small. Therefore, the sub rotary developing units 16 are more miniaturized compared to a developing device including a toner container in the interior thereof. In addition, an opening is formed in each of the sub rotary developing units 16 in order to supply toner into the sub rotary developing units 16.

Laser Unit

The laser unit 4 is a device that scans and exposes the photosensitive drum 2 based on the image data from the external device such as a computer. It is located above the upper left side (i.e., the upper rear side) of the photosensitive drum 2 and the rotational shaft of the rotary developing device 3. Specifically, the front end (i.e., the laser emitting end) of the laser unit 4 is located immediately above the rotational shaft of the rotary developing device 3, and the height of the rear end of the laser unit 4 is lower than the height of the upper surface of the rotary developing device 3. In other words, the entire laser unit 4 is tilted, with the laser emitting end tilting upward. The inner structure of the laser unit 4 is the same as the structure of a conventional laser unit, and comprises components such as a laser light source, a polygon mirror, and a motor for driving the polygon mirror. In addition, a reflective mirror 20 is located so that the laser light emitted from the laser unit 4 can strike the reflective mirror 20. Because of this, as shown in the dotted line in FIG. 2, the laser light emitted from the laser unit 4 is inflected by the reflective mirror 20 and travels over the upper side of the rotary development device 3. Then it is reflected onto the surface of the photosensitive drum 2.

Toner Storage Unit

The toner storage unit 5 stores toner to be supplied to each of the sub rotary developing units 16 located in the rotary developing device 3. It is located above the photosensitive drum 2 to the right side, and at the opposite end (i.e., the front side of the color printer 1) from the laser unit 4.

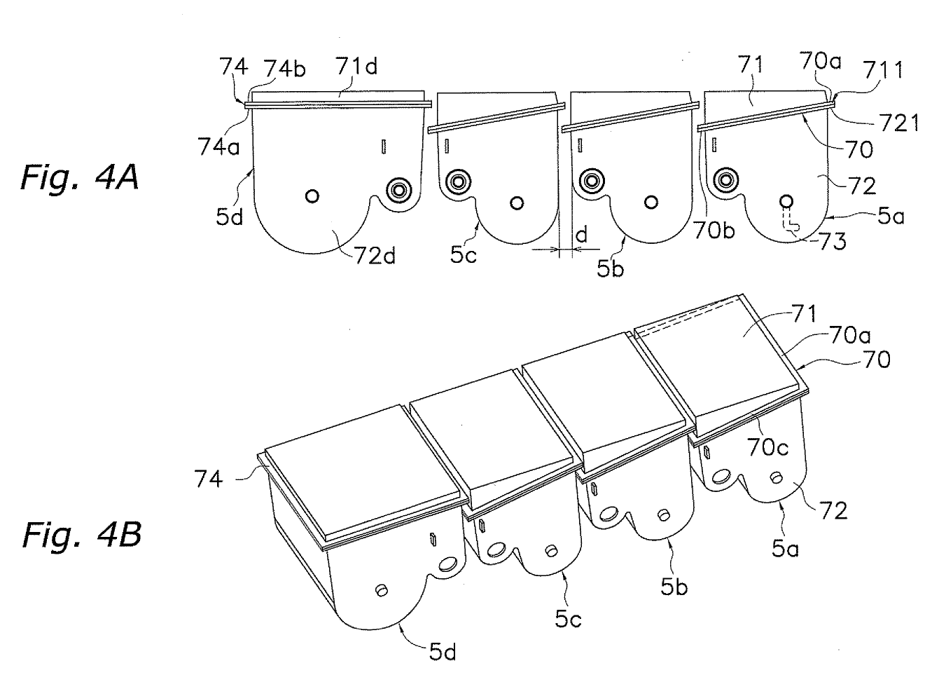

As shown in FIGS. 4A and 4B, the toner storage unit 5 is comprised of four toner containers 5a, 5b, 5c, and 5d. The toner containers 5a, 5b, 5c, and 5d are arranged in the lateral direction (i.e., the direction perpendicular to the cross-section of the color printer 1 shown in FIG. 2, or the front side of the color printer 1 when viewed from the side on which an operator operates the color printer 1 shown in FIG. 2), and stores cyan, magenta, yellow, and black color toners, respectively.

The toner containers 5a, 5b, and 5c are arranged in the lateral direction, and their structures are the same. Because of this, only the toner container 5a that contains yellow toner will be hereinafter explained. The toner container 5a is comprised of a container body 72 and a container lid 71. The container body 72 contains toner in the interior thereof. The container body 72 is formed in a box shape and is open at the top. In addition, the container body 72 has a toner vent hole (not shown in the figures) on its bottom surface. As shown in FIGS. 4A and 4B, the top of the container body 72 is slanted from the right to the left. Furthermore, a first brim member 721 is formed around and protrudes outward from the entire circumference of the top opening of the container body 72. A toner agitation mechanism 73 that agitates toner contained in the container body 72 is formed in the interior of the container body 72. The container lid 71 is formed to be open at the bottom thereof.

The bottom of the container lid 71 is slanted at the same angle as the top of the container body 72. In other words, the slope of the lower surface of the container lid 71 and that of the upper surface of the container body 72 are the same. In addition, a second brim member 711 is formed around and protrudes outward from the entire circumference of the bottom opening of the container lid 71. The second brim member 711 of the container lid 71 and the first brim member 721 of the toner body 72 are welded together by ultrasonic waves.

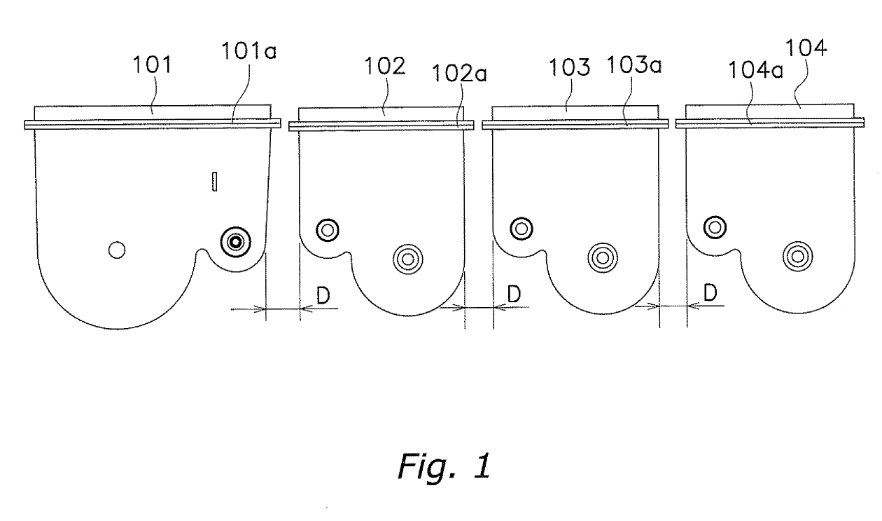

As shown in FIGS. 4A and 4B, a brim 70 is comprised of the first brim member 721 and the second brim member 711. Also, the brim 70 is comprised of four side members, that is, a right side brim member 70a, a left side brim member 70b, a front side brim member 70c, and a rear side brim member 70d. Here, “the right side” and “the left side” are defined as the right side and the left side of the toner container 5a shown in FIG. 4A. On the other hand, “the front side” is defined as the front view of the toner container 5a shown in FIG. 4A. Accordingly, “the rear side” is defined as the side opposite from the front side of the toner container 5a. In other words, the front side and the rear side are formed opposite each other, and the right side and the left side are formed opposite to each other. Furthermore, the right side brim member 70a and the left side brim member 70b are parallel. On the other hand, the front side brim member 70c and the rear side brim member 70d are slanted from the right to the left. Therefore, the height (in the vertical direction) of the right side brim member 70a (the first protruding portion) and the left side brim member 70b (the second protruding portion) is different. Note that the vertical direction is also referred to as the “second direction”. More specifically, the height of the lower surface of the right side brim member 70a is higher than the height of the upper surface of the left side brim member 70b. Therefore, it is possible to reduce the distance “d” between two adjacent containers compared to that in a conventional device by using the above described toner containers 5a, 5b, 5c, and 5d. Thus it is possible to miniaturize the image forming device. Here, the distance “d” is smaller than distance “D” shown in FIG. 1.

On the other hand, the toner container 5d that contains black toner is comprised of a container body 72d and a container lid 71d. The container body 72d contains toner in the interior thereof. The container body 72d is formed in a box shape and is open at the top. In addition, the container body 72d has a toner vent hole (not shown in the figures) on its bottom surface. As shown in FIGS. 4A and 4B, the top of the container body 72d is formed to be horizontal.

Furthermore, a third brim member 74b is formed around and protrudes outward from the entire circumference of the top opening of the container body 72d. A toner agitation mechanism that agitates toner contained in the container body 72d is formed in the interior of the container body 72d.

The container lid 71d is formed to be open at the bottom. The bottom of the container lid 71d is formed to be horizontal. In other words, the lower surface of the container lid 71d and the upper surface of the container body 72 are both formed to be horizontal. In addition, a fourth brim member 74a is formed around and protrudes outward from the entire circumference of the bottom opening of the container lid 71d. The fourth brim member 74b of the container lid 71d and the third brim member 74a of the toner body 72d are welded by means of ultrasonic waves. The height of the brim member 74, comprised of the third brim member 74a and the fourth brim member 74b, is higher than the height of the left side brim member 70b of the other toner containers 5a, 5b, and 5c. In addition, the capacity of the toner container 5d in which black toner is contained is larger than that of the other toner containers 5a, 5b, and 5c, because black toner is used more than the other color toners. However, the shape of the toner container 5d may be the same as that of the toner containers 5a, 5b, and 5c. In addition, the toner containers 5a, 5b, 5c, and 5d can be detached from the color printer 1 by pulling them from the front side of the color printer 1.

Toner Supply Device

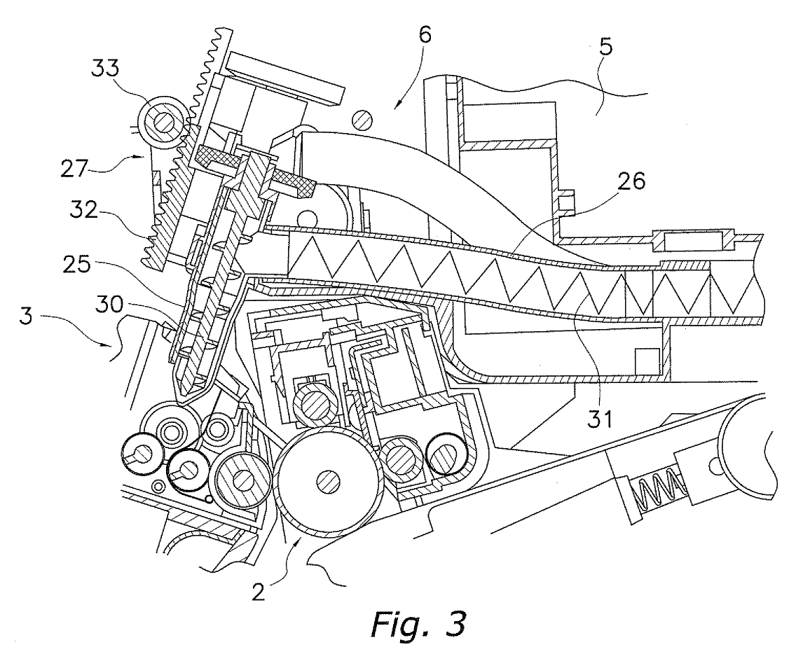

The toner supply device 6 supplies toner contained in the toner containers 5a, 5b, 5c, and 5d, all of which are located in the toner storage unit 5, to the sub rotary developing units 16. The toner supply device 6 is located in the space between the laser unit 4 and the toner storage unit 5 above the photosensitive drum 2. As shown in FIG. 3, the toner supply device 6 is comprised of four toner supply pipes 25 movable in the vertical direction, four transport pipes 26 connecting the portions of the toner storage unit 5 in which toners are stored to the corresponding toner supply pipes 25, and a drive mechanism 27 that moves the toner supply pipes 25 vertically. The toner supply device and the toner storage unit comprise the toner supply unit.

Each of the toner supply pipes 25 is formed to be extended in the vertical direction and located so that its upper end tilts to the front side of the color printer 1 (i.e., its bottom end tilts to the rear side of the color printer 1). Also, each of the toner supply pipes 25 has a tapered tip that can enter the inside of each of the corresponding sub rotary developing units 16 from an opening on each of these units when the pipe moves downward. In addition, a spiral component 30 that transports toner is rotatably installed in the inside of each of the toner supply pipes 25.

The transport pipes 26 are flexible and able to move according to the vertical movement of the toner supply pipes 25. In addition, a coil spring 31 is provided inside each of the transport pipes 26. The coil spring 31 is rotated by a driving mechanism (not shown in the figures), and transports toner inside each the transport pipes 26 to each of the toner supply pipes 25.

The driving mechanism 27 is comprised of racks 32 that are located along the axial direction of each of the toner supply pipes 25, and pinion gears 33 that engage with each of the racks 32, both of which are located outside the toner supply pipes 25. The pinion gears 33 are rotatably attached to the frame of the color printer 1 and driven by a device such as a motor (not shown in the figures). The driving mechanism 27 allows each of the toner supply pipes 25 to move into a “retract position” at the top and a “supply position” in which it extends downward so that the tip of each of the toner supply pipes 25 can enter inside the corresponding sub rotary developing unit 16 to supply toner to the sub rotary developing unit 16.

Intermediate Transfer Belt

The intermediate transfer belt 7 is located below the photosensitive drum 2 and the toner storage unit 5. The toner images formed on the photosensitive drum 2 with each color are sequentially transferred onto the surface of the intermediate transfer belt 7. The intermediate transfer belt 7 is looped around a driving roller 35 and a follower roller 36, which are located on the opposite ends. In addition, a portion of the transfer belt 7 comes in contact with the photosensitive drum 2 by means of a pair of first transfer rollers 37a and 37b.

Here, the above described intermediate transfer belt 7 and its surrounding components will be explained in detail. The driving roller 35 is located almost immediately below the contact portion of the photosensitive drum 2 and the rotary developing device 3. The center of the driving roller 35 is positioned lower than the bottom end of the rotary developing device 3. The driving roller 35 is driven by a driving device including a motor and a gear (not shown in the figure). The follower roller 36 is located at the bottom of the front side of the toner storage unit 5, and positioned in approximately the same height as the photosensitive drum 2. The spring 38 forces the follower roller 36 to the opposite direction from the driving roller 35. Thus, a predetermined tension is created for the intermediate belt 7. In addition, the first transfer rollers 37a and 37b are located adjacent to each other and below the photosensitive drum 2. Thus, a predetermined region of the transfer belt 7 comes in contact with the photosensitive drum 2.

A belt cleaning device 40 cleans the transfer belt 7, and is located on the rear side of the driving roller 35 and below the rotary developing device 3. The belt cleaning device 40 comprises a fur brush 41 that is located in a position opposing to the driving roller 35 and slides in contact with the transfer belt 7, a cleaning roller 42 that is located above the fur brush 41 and comes in contact therewith, a blade 43 that is located so that the tip thereof comes in contact with the surface of the cleaning roller 42, and a recovery spiral 44 that is arranged below the blade 43.

In this cleaning device 40, the residuals or attachments on the intermediate transfer belt 7 are scraped off by the fur brush 41, and collected by the cleaning roller 42. Then, the residuals and attachments on the surface of the cleaning roller 42 are scraped off by the blade 43 and collected in a recovery unit (not shown in the figure) by the recovery spiral 44.

Second Transfer Roller

The second transfer roller 8 transfers the image transferred on the intermediate transfer belt 7 onto a print sheet that is transported thereto. The second transfer roller 8 is located below the driving roller 35 to be opposed thereto, and comes in contact with the transfer belt 7 and sandwiches it with the driving roller 35. Bias voltage is applied to the second transfer roller 8 by an energizing unit (not shown in the figures) to transfer the image onto the print sheet.

Fixing Device

The fixing device 9 fixes the toner image on the print sheet by fusion, and is located below the rotary developing device 3 toward the rear side of the color printer 1. The fixing device 9 comprises a heating roller 9a that has a built-in heater, and a pressure roller 9b that is pressed against the heating roller 9a. The print sheet is held and transported between the heating roller 9a and the pressure roller 9b.

Discharge Portion

A discharge portion 50 is formed above the laser unit 4, the toner supply device 6, and the toner storage unit 5, as the upper surface of the color printer 1. The discharge portion 50 functions as a portion to hold the print sheet on which the image is formed when the print sheet is discharged. The discharge portion 50 is comprised of a curved portion that curves gradually upward from the side of the laser unit 4 (i.e., the rear side of the color printer 1) to the side of the toner storage unit 5 (i.e., the front side of the color printer 1), and a flat portion that is continuously formed to the curved portion and above the toner storage unit 5.

Feeding Cassette and Sheet Feeding Unit

A feeding cassette 52 is located at the bottom of the color printer 1. The feeding cassette 52 includes a stacking plate on which the print sheets are placed. In addition, a sheet feeding unit 51 is located on the front end of the feeding cassette 52 (i.e., the right side end of the feeding cassette 52 shown in FIG. 2) from which the print sheet is fed. The sheet feeding unit 51 feeds the print sheets that are stacked in the feeding cassette 52. The sheet feeding unit 51 has a forward feeding roller 53 that takes print sheets out of the print sheets stacked on the stacking plate, and a sheet feeding control mechanism 54 comprised of a pair of rollers that sends print sheets one at a time into the transport path. The sheet feeding cassette 52 can be pulled in a direction in which the print sheet is transported. In other words, the sheet feeding cassette 52 can be pulled out of the color printer 1 from its front side.

A transport mechanism is located between the sheet feeding unit 51 and the discharge portion 50, and transports print sheets from the sheet feeding unit 51 to the discharge portion 50. The transport mechanism comprises a first transport path 55 that is formed from the sheet feeding unit 51 to the second transfer roller 8, a second transport path 56 that is formed from the second transfer roller 8 to the fixing device 9, and a third transport path 57 that is formed from the fixing device 9 to the discharge portion 50. In addition, a branching claw 58 is located at the exit of the fixing device 9. Furthermore, a return transport path 59 is formed in an area located between this branching claw 58 and the first transport path 55 in order to return print sheets to the first transport path 55.

The first transport path 55 is comprised of a curved path 55a that transports the print sheet sent from the feeding cassette 52 upward and reverses the transport direction of the print sheet, and a straight path 55b that extends from the curved path 55a to the second transfer roller 8. These transport paths are composed of a guide plate and a pair of rollers for guiding and transporting the print sheet. Sensors are installed at predetermined places on these transport paths for detecting the location of the print sheet. In addition, a pair of sheet stopper rollers 60 is located on the straight path 55b in order to control the timing of transporting the print sheet.

The second transport path 56 is approximately linearly formed. The second transport path 56 is comprised of a guide plate, a pair of rollers for guiding and transporting the print sheet, and sensors that are formed on the predetermined positions to detect the location of the print sheet.

The third transport path 57 includes a vertical transport path that is formed downstream of the branching claw 58 in the transport direction. In other words, the print sheet is transported upward in the vertical direction after it passes the branching claw 58 and then discharged to the discharge portion 50. The third transport path 57 is also comprised of a guide plate and a pair of rollers for guiding and transporting the print sheet.

The return transport path 59 is a transport path which branches off downward from the third transport path 57 at a place where the branching claw 58 is mounted. The return transport path 59 extends below the fixing device 9, the second transport path 56, the second transport roller 8, and the pair of the sheet stopper rollers 60, and then extends upward so as to join the first transport path 55, at the upstream side of the sheet stopper rollers 60 in the transport direction. Namely, the return transport path 59 is a transport path located vertically between the sheet feeding cassette 52 and the straight path 55b of the first transport path 55 as well as the second transport path 56. Also, the return transport path 59 returns the print sheet that passed through the fixing device 9 to the upstream side of the pair of the sheet stopper rollers 60 located upstream of the second transfer roller 8 in the transport direction. The return transport path 59 also has a guide plate and a pair of transport rollers for guiding and transporting sheets and sensors that are formed on the predetermined positions to detect the print sheet.

Furthermore, a sheet feeding tray 65 is located beside the toner storage unit 5 and above the sheet feeding cassette 52, and comprises the front side sidewall of the color printer 1. The lower end of the sheet feeding tray 65 is rotatably supported in the vicinity region of the curved path 55a of the first transport path 55. The sheet feeding tray 65 has a pivot 65a at the lower end. The sheet feeding tray 65 can be freely opened to the predetermined position and closed. As shown in FIG. 2, when the sheet feeding tray 65 is pulled (i.e., opened), it pivots around the pivot 65a in the clockwise direction so that its upper end is inclined in the direction of the front side of the color printer 1. Accordingly, when the sheet feeding tray 65 is opened, it is possible to put print sheets thereon and supply the print sheets into the curved path 55a of the first transport path 55.

Image Forming Operation

An image forming operation will hereinafter be briefly explained. When the power of the color printer 1 is turned on, a variety of parameters and settings are initialized and default settings, such as setting of the temperature of the fixing device, are performed. Then, if the image data and a command to print the image data is input to the color printer 1 from a device (e.g., a computer) connected to this color printer 1, the following image forming operation is performed by the color printer 1. Note that the toner supply pipes 25 stay in the retracted position (i.e., the above described “retract position” at the top) while the image forming operation is performed.

First, the charge roller 10 charges the photosensitive drum 2. The laser unit 4 scans and exposes the photosensitive drum 2 based on the image data, and the electrostatic latent image is formed on the surface of the photosensitive drum 2. Then, the rotary developing device 3 rotates to the position where the sub rotary developing unit 16 containing the corresponding color is positioned adjacent to the photosensitive drum 2. The electrostatic latent image on the photosensitive drum 2 is developed with this corresponding toner color. The developed image is transferred to the intermediate transfer belt 7. A full color image is formed on the intermediate transfer belt 7 by sequentially repeating the above described operation with respect to each of the colors. Note that the residual toner remaining on the photosensitive drum 2 is cleaned by the drum cleaning device 11, and discharged to a waste toner container (not shown in the figure).

On the other hand, a print sheet is drawn out from the feeding cassette 52 by the forward feeding roller 53 and the feeding control mechanism 54 in the feeding unit 51. The print sheet is transported to the pair of the sheet stopper rollers 60 through the first transport path 55. Then, the print sheet is transported and guided from the pair of the sheet stopper rollers 60 to the second transfer roller 8 in synchronization with the timing of the image formation on the intermediate transfer belt 7. The second transfer roller 8 is in contact with the intermediate transfer belt 7. The full color image formed on the surface of the intermediate transfer belt 7 is transferred to the print sheet by applying the transfer bias to the second transfer roller 8. Then, the print sheet is guided to the fixing device 9 through the second transport path 56. The image is fixed onto the print sheet by the application of heat and pressure in the fixing device 9.

For single-sided printing, the print sheet is guided to the third transport path 57 by the branching claw 58, and discharged onto the discharge portion 50. On the other hand, for dual-sided printing, after an image is fixed onto the print sheet in the fixing device 9, the print sheet is transported to the third transfer path 57 side through the branching claw 58. Once the print sheet passes the branching claw 58, it is transported in the reverse direction. More specifically, it is guided to the return transport path 59 by the branching claw 58 and returned to the first transport path 55. Then, it is temporarily held by the pair of the sheet stopper rollers 60. After the image to be formed on the other side of the print sheet is formed on the surface of the intermediate transfer belt 7 in the same way as the above described operation, the print sheet standing by at the pair of the sheet stopper rollers 60 is transported towards the second transfer roller 8 at the appropriate timing. Thus, the image is formed on the other surface of the print sheet in the same way as the above described operation, and the print sheet is guided to the third transport path 57 through the branching claw 58 and discharged onto the discharge portion 50.

Toner Supply Operation

When supplying toner to one of the sub rotary developing units 16, one of the toner supply pipes 25 moves downward to supply toner. More specifically, when a motor (not shown in the figures) is driven, the pinion gear 33 is rotated through a gear. This moves the toner supply pipe 25 on which a rack 32 is fixed downward. Toner is supplied to the toner supply pipe 25 through one of the transport pipes 26 from the toner storage unit 5. Then, the tip of the toner supply pipe 25 enters the sub rotary developing unit 16 through a toner supply hole. When the toner supply pipe 25 moves downward, an external cylinder that comprises the toner supply pipe 25 rotates around an internal cylinder. At the point when the tip of the toner supply pipe 25 enters the sub rotary developing unit 16, an opening on the external cylinder is aligned with an opening on the internal cylinder. In other words, the shutter mechanism of the toner supply pipe 25 is opened and toner contained inside the toner supply pipe 25 is supplied to the sub rotary developing unit 16.

In addition, when the toner supply pipe 25 is set to the position in which toner is supplied to the sub rotary developing unit 16, the light path from the laser unit 4 to the photosensitive drum 2 is blocked by the toner supply pipe 25. However, the toner supply operation performed by the toner supply pipe 25 and the image formation operation are not simultaneously performed. Therefore, this will not be a problem at all.

As described above, the space wasted when arranging toner containers horizontally can be reduced in the color printer according to the present invention.

### Alternative Embodiments

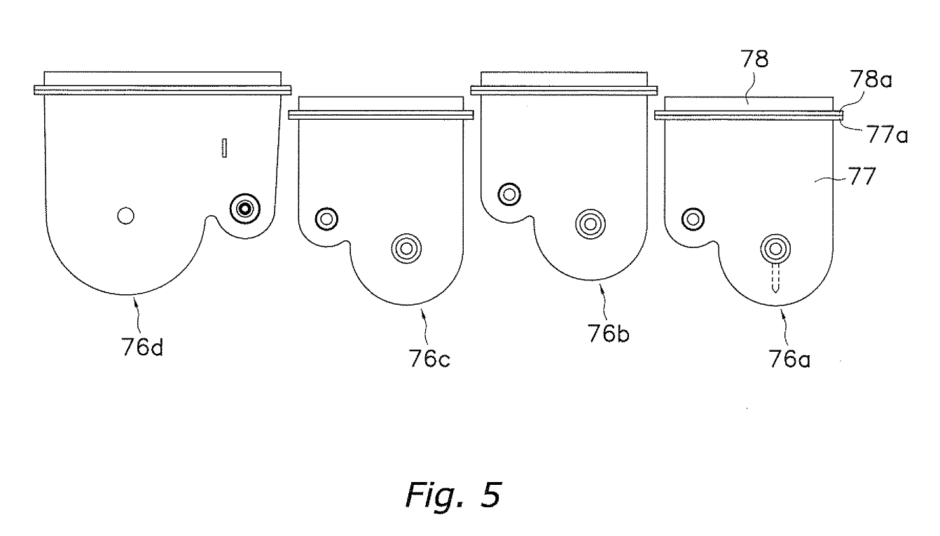

Referring now to FIGS. 5 to 7, the toner containers of image forming devices in accordance with alternative embodiments will now be explained. In view of the similarity between the first and alternative embodiments, the parts of the alternative embodiments that are identical to the parts of the first embodiment will be given the same reference numerals as the parts of the first embodiment. Moreover, the descriptions of the parts of the alternative embodiments that are identical to the parts of the first embodiment may be omitted for the sake of brevity.

### First Alternative Embodiment

FIG. 5 is a diagram showing an example of the layout of containers 76a, 76b, 76c, and 76d in accordance with a first alternative embodiment of the present invention. The containers 76a, 76b, and 76c are comprised of the same components, that is, a container body 77 and a container lid 78, respectively. However, the structure of the container 76d containing the black toner and the structure of the other containers 76a, 76b, and 76c are different. The structure of the container 76d containing the black toner is the same as the container in accordance with the above described first embodiment of the present invention. Each of the containers 76a, 76b, and 76c is comprised of a container body 77 and a container lid 78. The container body 77 is formed to be open at the top thereof, and the container lid 78 is formed to be open at the bottom thereof. In addition, a brim member 77a is formed around the entire circumference of the top opening of the container body 77 so as to protrude outward. In addition, a brim member 78a is formed around the entire circumference of the bottom opening of the container lid 78 so as to protrude outward. Here, each of the four side members comprising the brim portions 77a and 78a is formed horizontally. Furthermore, four containers 76a, 76b, 76c, and 76d are alternately arranged in two height positions. In other words, the container 78a containing yellow toner and the container 76c containing cyan toner are arranged in the same height position, which is relatively low. The container 76b containing magenta toner and the container 76d containing black toner are arranged in the same height position, which is higher than the height position in which the containers 78a and 76c are arranged. Therefore, even if the adjacent containers are closely arranged next to each other, the brim members of the containers do not overlap with each other.

As with the first embodiment of the present invention, in the present alternative embodiment of the present invention, the distance between each of the adjacent containers is reduced compared to a conventional device. Therefore, it is possible to miniaturize the image forming device.

### Second Alternative Embodiment

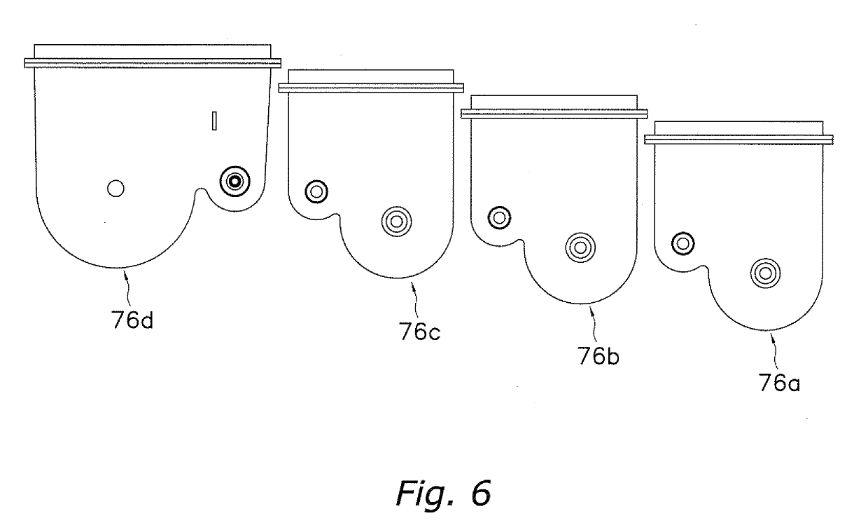

FIG. 6 is a diagram showing an example of a layout of containers 76a, 76b, 76c, and 76d in accordance with a second alternative embodiment of the present invention. The structures of the toner containers 76a, 76b, 76c, and 76d in accordance with the second alternative embodiment are the same as those in accordance with the first alternative embodiment shown in FIG. 5. However, the arrangement of the containers 76a, 76b, 76c, and 76d in the second alternative embodiment is different from the first alternative embodiment. In short, in the second alternative embodiment, the containers 76a, 76b, 76c, 76d are arranged so that the height of the toner container 76d containing black toner is the highest and the height of the toner container 78a containing yellow toner is the lowest among the four. Because of this, as in the case with the first alternative embodiment, even if the adjacent containers are arranged to each other, the brim members of the containers do not overlap with each other. Accordingly, the distance between each two adjacent containers can be set to be relatively small compared to a conventional device. Thus, it is possible to miniaturize the image forming device.

### Third Alternative Embodiment

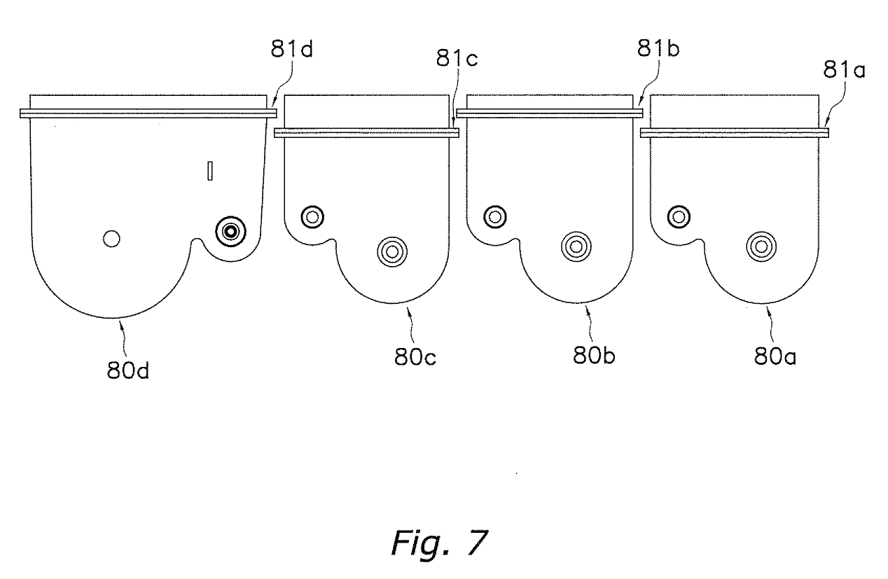

FIG. 7 is a diagram showing an example of a layout of toner containers 80a, 80b, 80c, and 80d in accordance with a third alternative embodiment of the present invention. In the third alternative embodiment, the toner containers 80a, 80b, 80c, and 80d are arranged at the same height. However, brim members of adjacent containers have different heights. Brim members 81a, 81b, 81c, and 81d are formed horizontally around the circumference of the containers 80a, 80b, 80c, and 80d, respectively. In addition, the brim member 81a that is formed on the lateral sides of the container 80a containing yellow toner, and the brim member 81c that is formed on the lateral sides of the container 80c containing magenta toner, are arranged in a relatively low position. The brim member 81b that is formed on the lateral sides of the container 80b containing cyan toner, and the brim member 81d that is formed on the lateral sides of the container 80d containing black toner, are arranged in a position that is higher than the position in which the brim members of the toner containers 80a and 80c are arranged. Therefore, even if the brim members are formed horizontally on the lateral sides of all the containers and the containers are arranged at the same height, the brim members of each of the adjacent containers will not overlap with each other. Thus, as with the above described embodiments of the present invention, the distance between each of the adjacent containers can be reduced compared to a conventional device.

### Fourth Alternative Embodiment

In the above described embodiments, the containers have brims welded by ultrasonic waves on the container bodies and container lids. However, it is possible to apply the present invention to containers that have other protrusions protruding in a direction in which the toner containers are arranged. In addition, in the above described embodiments, the toner containers are arranged in the horizontal direction. However, they may be arranged in the vertical direction.

### Fifth Alternative Embodiment

In the above described embodiments, the brim 70 comprised of the first brim member 721 and the second brim member 711 is formed around the entire circumference of the container body 72 and the container lid 71. However, the present invention is not limited to this. For example, the containers may have only the pair of the right side brim member 70a and the left side brim member 70b, or only the pair of the front side brim member 70c and the rear side brim member 70d. When the pair of the right side brim member 70a and the left side brim portion 70b are formed, the toner containers are arranged parallel to each other in the horizontal direction. On the other hand, when only the front side brim portion 70c and the rear side brim portion 70d are formed, the toner containers are arranged parallel to each other from the front to the rear side.

### GENERAL INTERPRETATION OF TERMS

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A toner container for an image forming device, comprising:
a container configured to contain toner in the interior thereof,
a first protruding portion formed on one of the lateral sides of the container so as to protrude in a first direction; and
a second protruding portion formed on the lateral side opposite the lateral side on which the first protruding portion is formed so as to protrude in the first direction;
wherein the first protruding portion and the second protruding portion are formed in different positions on the container in a second direction that is perpendicular to the first direction.

2. The toner container according to claim 1, wherein the container further comprises:
a container body that has an opening formed therein, and a container body side brim member formed around the entire circumference of the opening of the container body so as to protrude outward; and
a container lid that is configured to cover the opening of the container body, the container lid comprising an opening, and a container lid side brim member which is formed around the entire circumference of the opening of the container lid so as to protrude outward, the container lid configured to be connected to the container body side brim member;
wherein the container body side brim member and the container lid side brim member comprise the first protruding portion and the second protruding portion.

3. The toner container according to claim 2, wherein a pair of protruding portions connecting the first protruding portion and the second protruding portion are formed on opposite lateral sides of the container.

4. The toner container according to claim 2, wherein the container body further comprises a toner agitating mechanism configured to agitate toner in the interior thereof.

5. The toner container according to claim 3, wherein the container body further comprises a toner agitating mechanism configured to agitate toner in the interior thereof.

6. A full color image forming device that forms an image with a plurality of color toners, comprising:
an image forming unit configured to form an image;
a fixing unit configured to fix the image formed in the image forming unit on a print sheet;
a sheet transport unit configured to transport the print sheet to the image forming unit and the fixing unit; and
a toner supply unit configured to supply toner to the image forming unit, the toner supply unit comprising a plurality of toner containers arranged in a first direction, each toner container comprising:
a container body configured to contain toner in the interior thereof and having an opening formed therein, and a container body side brim member formed around the entire circumference of the opening of the container body so as to protrude outward; and
a container lid having an opening formed therein, and a container lid side brim member formed around the entire circumference of the opening of the container lid so as to protrude outward, the container lid side brim member configured to be connected to the container body side brim member;
wherein the plurality of toner containers are arranged so that the container body side brim member and the container lid side brim member formed on adjacent toner containers of the plurality of toner containers are not arranged in the same position in a second direction perpendicular to the first direction, and at least a portion of the container body side brim member and the container lid side brim member formed on adjacent toner containers are arranged to overlap in the first direction.

7. The full color image forming device according to claim 6, wherein the container body side brim member and the container lid side brim member comprise a first protruding portion formed on one lateral side of the container body and the container lid in the first direction, and a second protruding portion formed on a lateral side opposite the lateral side on which the first protruding portion is formed in the first direction; and
the first protruding portion and the second protruding portion are formed in different positions from each other in the second direction.

8. The full color image forming device according to claim 6, wherein a pair of protruding portions on the container body and container lid connecting the first protruding portion and the second protruding portion are formed on opposite lateral sides of the container.

9. The full color image forming device according to claim 6, wherein at least two of the plurality of toner containers are formed in the same shape, and the adjacent toner containers of the plurality of toner containers are arranged in different positions from each other in the second direction.

10. The full color image forming device according to claim 6, wherein the plurality of toner containers are detachable from the toner supply unit along a third direction that is perpendicular to the first direction.

11. The toner container according to claim 2, wherein the container body side brim portion and the container lid side brim portion are fixed to each other by means of welding.

12. The full color image forming device according to claim 6, wherein one of the plurality of toner containers is larger than the other toner containers.

13. The full color image forming device according to claim 6, wherein the plurality of toner containers are arranged so that the positions of the container body side brim members are alternately arranged in different positions in the second direction.
